(19) United States
(12) Patent Application Publication
(10) Pub. No.: US 2017/0324105 A1
(43) Pub. Date: Nov. 9, 2017

(54) METHOD FOR CONTROLLING A FUEL CELL

(71) Applicants: COMPAGNIE GENERALE DES ETABLISSEMENTS MICHELIN, CLERMONT-FERRAND (FR); MICHELIN RECHERCHE ET TECHNIQUE S.A., Granges-Paccot (CH)

(72) Inventors: VINCENT BRAILLARD, Clermont-Ferrand (FR); GINO PAGANELLI, Clermont-Ferrand (FR)

(73) Assignee: COMPAGNIE GENERALE DES ETABLISSEMENTS MICHELIN, CLERMONT-FERRAND (FR)

(21) Appl. No.: 15/537,480

(22) PCT Filed: Dec. 17, 2015
(86) PCT No.: PCT/EP2015/080171

§ 371 Date: Jun. 19, 2017

(30) Foreign Application Priority Data
Dec. 19, 2014 (FR) 1462902

(51) Int. Cl. H01M 8/04746; H01M 8/04828; H01M 8/04007; H01M 8/04302; H01M 8/04029; H01M 8/04303; H01M 8/04858; H01M 8/0432

(52) U.S. Cl. CPC H01M 8/04768; H01M 8/04895; H01M 8/04828; H01M 8/04358; H01M 8/04302; H01M 8/04029; H01M 8/04303; H01M 8/04067

(57) ABSTRACT

A method is provided for controlling an ion-exchange-membrane type fuel-cell stack installed in a system that includes a cooling circuit and a cooling pump for circulating coolant liquid in the cooling circuit. The method includes, in a start-up phase of starting up the fuel-cell stack, determining an internal temperature of the fuel-cell stack; measuring a temperature in the cooling circuit; applying a start-up current to the fuel-cell stack; and, in parallel: controlling the cooling pump to operate in a pulsed mode when the internal temperature of the fuel-cell stack is above a first predetermined threshold and the temperature of the cooling circuit is below a second predetermined threshold, and controlling the cooling pump to operate in a continuous mode when the temperature in the cooling circuit rises above the second predetermined threshold.

### TECHNICAL FIELD

The present invention relates to fuel cell stacks and in particular, but not exclusively, to fuel cell stacks in which the electrolyte takes the form of a polymer membrane (i.e. PEFCs (polymer electrolyte fuel cells)).

More particularly, the present invention relates to the use of such fuel cell stacks under especially cold temperature conditions, and to the strategies for starting up such stacks under these conditions.

### BRIEF DESCRIPTION OF THE INVENTION

It is known that fuel cell stacks make it possible to generate electrical power directly, via an electrochemical redox reaction, from a fuel gas and an oxidant gas, without an intermediate conversion to mechanical energy. This technology seems promising for automotive applications in particular. A fuel cell stack includes a stack of basic cells, each comprising an anode, a cathode and an ion exchange membrane acting as an electrolyte. During the operation of a fuel cell stack, two simultaneous electrochemical reactions take place: an oxidation of the fuel at the anode, and a reduction of oxidant at the cathode. These two reactions produce positive and negative ions which combine together at the membrane and generate electricity in the form of a potential difference. In the case of an oxygen-hydrogen fuel cell stack, it is the H⁺and O⁻ions that combine together.

The membrane electrode assemblies, or cells, are stacked in series and separated by a bipolar plate that conducts the electrons from the anode of one cell to the cathode of the neighbouring cell. For this purpose, channels are provided over both faces of the bipolar plates in contact with the membrane electrode assemblies. Each channel has an inlet through which the fuel or the oxidant enters, and an outlet through which excess gases and the water produced by the electrochemical reaction are discharged.

Fuel cell stacks have numerous potential applications, in particular mobile applications. In this case, they may be called upon to operate under extreme temperature conditions. Thus, when the exterior temperature drops substantially below zero, for example of the order of −20° C., the internal temperature of the fuel cell stack also drops, until occasionally reaching temperatures below 0° C. at atmospheric pressure. The objective of a cold start procedure for a fuel cell stack is to raise the internal temperature of the fuel cell stack above the freezing point of water before the fuel cell stack starts to discharge the water produced by the electrochemical reaction.

It is therefore advantageous to implement a method for controlling a fuel cell stack that allows the integrity of the stack to be guaranteed even in the event of use at low temperatures. Control methods are also known that consist in performing, after the shut-down preceding the start-up, a dry-out operation in order to remove the water remaining in the circuits of the fuel cell stack. This makes it possible entirely to avoid the circuits freezing during the phases in which the fuel cell stack is at standstill.

However, in the event of temperatures substantially below zero, this dry-out operation is not sufficient to prevent damage to the stack. Specifically, if the stack is started up with no aid other than having been dried out beforehand, the heat losses from the fuel cell stack alone could be used to raise its own temperature. However, the thermal inertia of a fuel cell stack, and of its cooling circuit, is too high to be overcome solely through the use of heat losses.

In order to remedy this, a known solution consists in delaying the start of circulation of the coolant liquid, so as to have to warm up only the volume of water contained in the stack and not that contained in the external portion of a primary cooling circuit of the fuel cell stack, comprising in particular pipes, a cooling pump and a thermostatic valve.

However, this solution has multiple drawbacks. The first is that the delay in starting the circulation of the coolant liquid leads to local overheating of the fuel cell stack, which is not being cooled. The second is that it is not possible, in such a solution, to determine the internal temperature of the fuel cell stack. Specifically, the temperature sensors are generally placed in the cooling circuit of the fuel cell stack. However, if the cooling circuit is not in operation, it is impossible to obtain the measurement of the internal temperature of the stack.

Furthermore, it has been observed that, in the start-up procedures known from the prior art, an injection of very cold coolant liquid could result in a substantial drop in the voltage across the terminals of the cells of the fuel cell stack.

The present invention therefore aims to propose a method that allows a cold start of a fuel cell stack to be performed while maintaining the integrity of the stack, and remedying the drawbacks of the prior art.

Thus, the invention relates to a method for controlling an ion exchange membrane fuel cell stack, the stack being installed in a system additionally comprising a liquid cooling circuit and a pump for circulating the coolant liquid, the method comprising a phase of starting up the fuel cell stack, this start-up phase comprising the following steps:
the internal temperature of the fuel cell stack is determined;
the temperature in the liquid cooling circuit is measured;
a start-up current is applied to the fuel cell stack and, in parallel;
   when the internal temperature of the stack is above a first predetermined threshold, and the temperature of the coolant liquid before entering the stack is below a second predetermined threshold, the cooling pump is ordered to operate in pulsed mode, and when the temperature in the cooling circuit rises above the second predetermined threshold, the cooling pump is ordered to operate in continuous mode.

The internal temperature of the stack is an estimate of the stack core temperature. The first predetermined threshold is chosen such that the coolant liquid is not set in motion too soon, which could lead to a risk of thermal shock and thus to the freezing of the water produced in the stack that is still cold. The second threshold is chosen so as to avoid any local overheating of the uncooled fuel cell stack, without however causing a drop in voltage across the terminals of the cells of the stack.

Specifically, activation of the cooling pump in pulsed mode makes it possible to instil water that is still cold into the stack gradually, and thus to hold an acceptable voltage across the terminals of the cells of the fuel cell stack.

In another embodiment, as an alternative to pulsed mode control, a variable speed cooling pump with a very low flow rate capacity is used. However, the viscosity of the coolant liquid at very low temperature is very high and a low flow rate is difficult to achieve using a conventional cooling pump designed for a liquid of lower viscosity and a much higher flow rate. Pulsed mode control allows the necessary level of finesse in the control of the average flow rate to be achieved without having to use a highly elaborate pump. Pulsed mode control additionally makes it possible to provide a better guarantee that the liquid is properly set in motion.

According to embodiments, the first threshold is set to 20° C. at atmospheric pressure, and the second threshold is set to 5° C. at atmospheric pressure.

In one advantageous embodiment, the internal temperature of the stack is determined while taking account of the heat capacity and the mass of the materials constituting the stack, and the thermal energy dissipated by the stack. Thus, for example, a formula of the following type is used:

$$Teta\_FC = {\sum }_{k = 0}^{n} \frac{( ( {UCell}_{LHV} \cdot NbCell ) - {U}_{FC} ) \cdot {I}_{FC}}{{M}_{1} \cdot {C}_{1} + {M}_{2} \cdot {C}_{2}} + {Teta}_{init}$$

$${UCell}_{LHV} = \frac{{MW}_{H 2} \cdot LHV \cdot 1000}{2 \cdot F} = 1.2531 V$$

Where:
Teta_FC: Estimated termpature of the PEMFC [°C ]
NbCell: Number of cells forming the stack [16]
UFC: Total voltage on the stack [V]
IFC: Stack current [A]
M1: Mass of the coolant liquid inside the PEMFC [kg]
C1: Heat capacity of the coolant liquid [J/kgK]
M2: Mass of the bipolar plates [kg]
C2: Heat capacity of the bipolar plates [J/kgK]

In one particular embodiment, the applied start-up current is a ramp from 0.015 A/cm²/s, with a maximum value of 0.5 A/cm². This corresponds, for a stack of 200 cm², to a current of 100 A. However, in certain situations, the application of such a ramp may lead to a substantial drop in the voltage across the terminals of the cells of the fuel cell stack. In order to avoid such a collapse and its consequences on the operation of the stack, the applied current is adjusted, in one particular embodiment, so as to guarantee that the voltage across the terminals of each of the cells is higher than or equal to 0.2 volt. This is achieved using a regulator that transmits a maximum current value to a unit for controlling the power delivered by the fuel cell stack, such as a DC-to-DC converter, for example.

In yet another embodiment, the method for controlling the fuel cell stack includes a phase of drying out the fuel cell stack beforehand using atmospheric air, this dry-out phase taking place before the ambient temperature drops below 0° C. In one embodiment, this temperature is set to 5° C.

The pump is controlled such that activation time is constant. This is set to the minimum required to guarantee that the cooling fluid is set in motion under all circumstances. It is dependent on the dynamics of the pump and on head losses in the circuit of the stack. For example, the duration of operation is set to 0.6 second. The standstill time of the pump between two pulses is variable. It is expected for the temperature model of the stack to return a temperature value that is 1° C. higher with respect to the preceding pulse so as to cause a gradual increase in the temperature of the core of the fuel cell stack. The time between two pulses is moreover limited to between a minimum time of 2 seconds and a maximum time of 12 seconds. In another embodiment, the duration of standstill of the pump is determined so as to guarantee that the mean voltage across the terminals of the cells of the stack returns to a value that is higher than a predetermined value between two pulses, for example 0.6 V. Specifically, each pulse results in the introduction of a small amount of coolant liquid that is still cold, resulting in a drop in the voltage of the cells.

In one embodiment corresponding to a fuel cell stack of 16 cells of 200 cm², this dry-out with air is performed using the following parameters:
The dry-out is performed using atmospheric air blown by a compressor.
At the anode, the air is blown at a flow rate of 15 litres per minute.
At the cathode, the air is blown at a flow rate of 85 litres per minute.
The dry-out is performed when the ambient temperature falls below 5° C.; it is stopped once the impedance of the stack, measured at 1 kHz, reaches the value of 40 milliohms.
In addition, the dry-out is preferably performed after a period of operation of the stack just before the latter is shut down with a cathode stoichiometry that is higher than or equal to 2.8, and preferably without wetting.
Under these conditions, the dry-out is performed in less than 90 seconds. Under other conditions, for example if the stoichiometry was previously 2, the dry-out time then becomes equal to around seven minutes.

### BRIEF DESCRIPTION OF THE FIGURES

Other objectives and advantages of the invention will appear clearly in the following description of a preferred, but non-limiting, embodiment, illustrated by the following figures in which:

FIG. 1 shows the voltages across the terminals of the cells of a fuel cell stack in the case that the cooling pump is activated in continuous mode in a cold start phase.

FIG. 2 shows the variation in multiple temperatures within the fuel cell stack in the case that the cooling pump is started up after a delay, and activated in pulsed mode in a cold start phase.

FIG. 3 shows the voltages across the terminals of the cells of a fuel cell stack in the case that the cooling pump is started up after a delay, and activated in pulsed mode in a cold start phase.

### DESCRIPTION OF THE BEST EMBODIMENT OF THE INVENTION

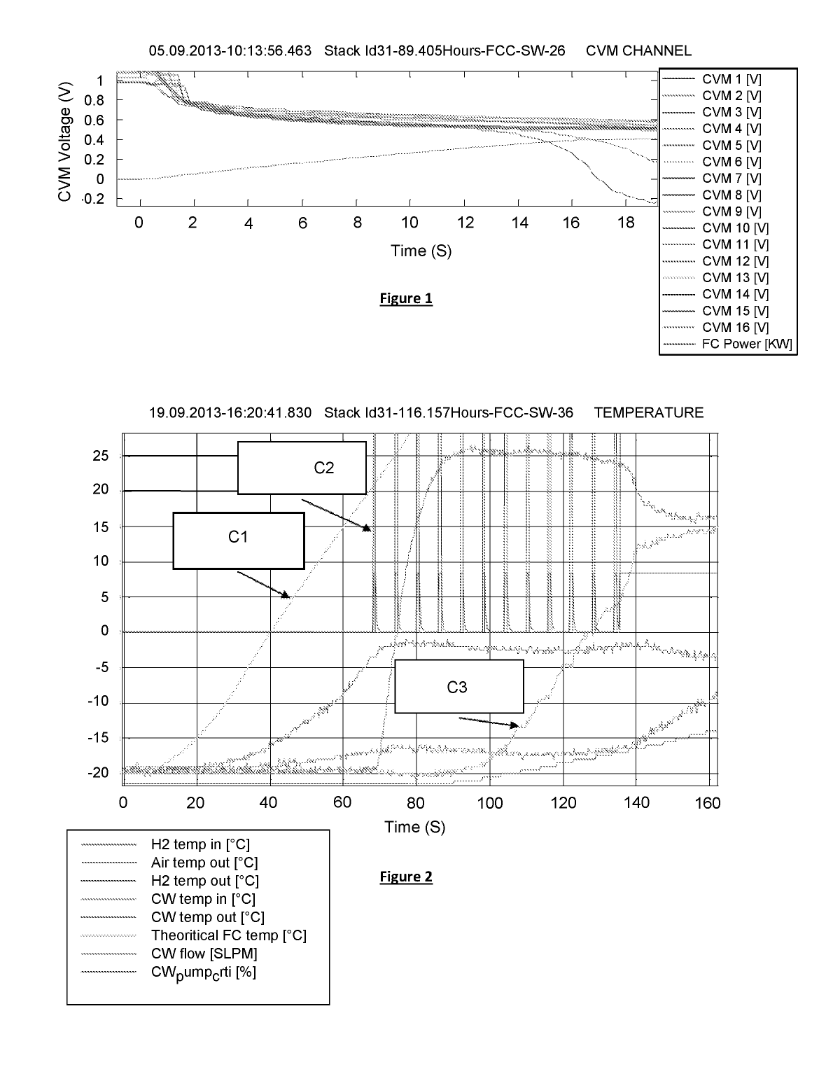

FIG. 1 shows the variation in the voltages across the terminals of the cells of a fuel cell stack during a cold start at −15° C. managed according to the methods of the prior art, namely by operating the cooling pump in continuous mode.

A gradual decrease in the voltage across the terminals of the set of cells is observed, followed by a collapse, starting at 13 seconds, of the voltage across the terminals of the first cell (lowest curve on the graph), followed shortly after by the voltage across the terminals of the second cell.

This rapid drop in voltage reveals a blockage linked to the freezing of the water produced in the fuel cell stack. As a result, the operation of the stack is negatively affected.

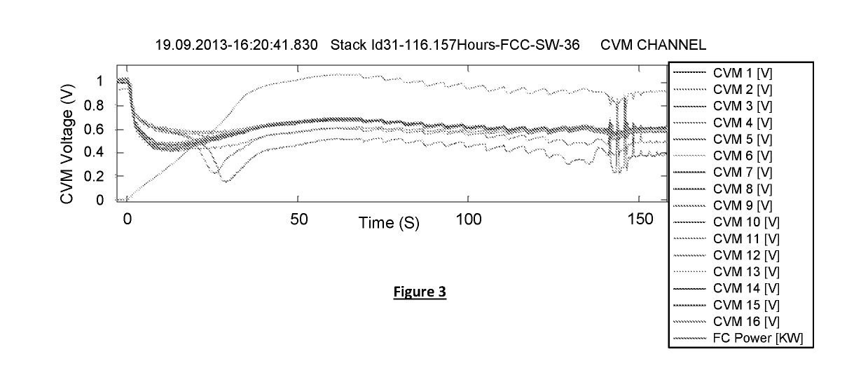

FIGS. 2 and 3 show the variation in parameters in a fuel cell stack for which a control method according to the invention is implemented. Thus, these two graphs show the variation for a cold start during which the stack is first operated without circulation of coolant liquid, then the cooling pump is operated in pulsed mode.

In FIG. 2, the curve C1 shows the estimated temperature of the fuel cell stack, the curve C2 shows the control setpoint of the cooling pump and the curve C3 shows the temperature at the inlet of the stack. After around 65 seconds, the temperature, shown by curve C1, reaches a value of 20° C. This value corresponds to a first predetermined threshold in one embodiment of the invention. The cooling pump, or water pump, is then controlled in pulsed mode, as shown on the curve C2.

After 135 seconds of operation, the temperature of the coolant liquid at the inlet of the stack, shown on curve C3, becomes higher than 5° C. This value corresponds to a second predetermined threshold in one embodiment of the invention. The cooling pump is then operated in continuous mode. From this moment on, the coolant liquid circulates continuously, resulting in quite a rapid decrease, then disappearance, of the difference in temperature of the coolant liquid between the inlet and the outlet of the fuel cell stack.

At the same time, FIG. 3 shows the corresponding variation in the individual voltages of the cells of the fuel cell stack when a method according to the invention is implemented. It is observed in this figure that, unlike in FIG. 1, the first cells of the fuel cell stack retain an acceptable voltage level, or have a voltage level that quickly bounces back, when the cooling pump is activated. The cooling pump is activated in pulsed mode. It is observed that each injection of cold water results in a drop in the set of voltages, shown in FIG. 3 by ripples. The frequency of the pulses of the cooling pump, and hence of the injection of coolant liquid, is determined so as to allow time for the voltage across the terminals of the cells to return to an acceptable level before another injection. In the present example, one injection takes place every 0.6 second.

Such a control method makes it possible to warm up the liquid contained in the cooling circuit while holding an acceptable voltage across the terminals of the cells of the fuel cell stack throughout the start-up phase.

1-7. (canceled)

8. A method for controlling an ion-exchange-membrane type fuel-cell stack installed in a system that includes a cooling circuit and a pump for circulating coolant liquid in the cooling circuit, the method comprising a start-up phase of starting up the fuel cell stack, the start-up phase including steps of:
determining an internal temperature of the fuel-cell stack;
measuring a temperature in the cooling circuit;
applying a start-up current to the fuel-cell stack, and,
when the internal temperature of the fuel-cell stack is above a first predetermined threshold, in parallel:
controlling the cooling pump to operate in a pulsed mode when the temperature of the cooling circuit is at or below a second predetermined threshold, and
controlling the cooling pump to operate in a continuous mode when the temperature in the cooling circuit rises above the second predetermined threshold.

9. The method according to claim 1, wherein the first predetermined threshold is 20° C. at atmospheric pressure.

10. The method according to claim 8, wherein the second predetermined threshold is 5° C. at atmospheric pressure.

11. The method according to claim 8, wherein the step of determining the internal temperature of the fuel-cell stack takes into account:
a heat capacity and a mass of materials constituting the fuel-cell stack, and
thermal energy dissipated by the fuel-cell stack.

12. The method according to claim 8, wherein, in the step of applying the start-up current, the start-up current is ramped at a rate of 0.015 A/cm²/s up to a limit of 0.5 A/cm².

13. The method according to claim 8, further comprising a dry-out phase of the fuel-cell stack, the dry-out phase including a step of drying out the fuel-cell stack after each shut-down of the fuel cell stack.

14. The method according to claim 8, wherein an activation frequency of the cooling pump in the pulsed mode is determined so as to achieve a rise in the internal temperature of the fuel-cell stack by a predetermined value between two pulses.
